(19) United States
(12) Patent Application Publication
(10) Pub. No.: US 2018/0298651 A1
(43) Pub. Date: Oct. 18, 2018

(54) Railcar Door Locking Pin and Receiver

(71) Applicant: Trinity North American Freight Car, Inc., Dallas, TX (US)

(72) Inventor: Robert J. Cencer, Tipton, MI (US)

(21) Appl. No.: 15/952,447

(22) Filed: Apr. 13, 2018

Related U.S. Application Data
(60) Provisional application No. 62/486,775, filed on Apr. 18, 2017.

(51) Int. Cl. E05B 83/02; B61D 19/00; E05B 79/04; E05B 85/22; E05C 17/48

(52) U.S. Cl. CPC E05B 83/02; B61D 19/004; B61D 19/001; E05B 79/10; E05B 85/22; E05C 17/48; E05B 79/04

(57) ABSTRACT

An apparatus includes one or more locking pins coupled to a railcar door of a railcar. Each locking pin includes an inserted portion at a first end of the locking pin. The inserted portion includes a pin taper in the direction towards the first end of the locking pin. The apparatus further includes a first receiver coupled to the railcar. The first receiver defines a recess. The recess comprises a receiver taper compatible with the pin taper. Inserting the inserted portion of a respective one of the one or more locking pins into the recess of the first receiver restricts movement of the railcar door.

### TECHNICAL FIELD

This disclosure relates generally to railcar doors, and in particular to railcar door locking mechanisms.

### BACKGROUND

Existing railcars include one or more end doors to access to the interior of the railcar to load and unload cargo or otherwise access the interior of the railcar. Auto Rack cars (also referred to as autoracks) are a type of railcar configured to store and transport automobiles and/or vehicles (e.g., cars, trucks, motorcycles, etc.). Existing Auto Rack cars, and other railcars, may include one or more locking pins and receivers to hold the doors in a fixed position, e.g., open or closed. Conventional locking pins and receivers include a cylindrical locking pin and a receiver having a cylindrical recess with a diameter larger than the diameter of the locking pin. While conventional locking pins and receivers may restrict significant transverse movement of the doors, i.e., the doors may be maintained closed or open, the spacing between the locking pin and receiver recess allows the doors to move and vibrate. These limited movements may increase wear of certain door components while the railcar is moving. The increased wear may shorten the lifetime of the door components, requiring accelerated maintenance and replacement.

### SUMMARY

According to certain embodiments, an apparatus includes one or more locking pins coupled to a railcar door of a railcar. Each locking pin includes an inserted portion at a first end of the locking pin. The inserted portion includes a pin taper in the direction towards the first end of the locking pin. The apparatus further includes a first receiver coupled to the railcar. The first receiver defines a recess. The recess includes a receiver taper compatible with the pin taper. The inserted portion of a respective one of the one or more locking pins inserted into the recess of the first receiver restricts movement of the railcar door.

In certain embodiments, the one or more locking pins include a first locking pin and a second locking pin. The first locking pin is disposed proximate a bottom of the railcar door. The second locking pin is disposed proximate a top of the railcar door.

In certain embodiments, the apparatus further includes a second receiver coupled to the railcar. The second receiver defines a recess. The recess includes a receiver taper compatible with the pin taper. In some embodiments, a position of the first receiver corresponds to a closed position of the railcar door. A position of the second receiver corresponds to an open position of the railcar door.

In certain embodiments, each of the one or more locking pins is coupled to a spring. The spring is configured provide a force on the respective locking pin to insert the inserted portion of the respective locking pin into the first receiver when the respective locking pin is disposed over the first receiver.

In certain embodiments, the one or more locking pins are coupled to the rotation of a square key hole defined in the railcar door such that a respective locking pin is removed from the first receiver when the square key hole is rotated.

In certain embodiments, the first receiver is lubricated.

In certain embodiments, the pin taper and the receiver taper are the same taper.

According to certain embodiments, a method includes providing a first tapered locking pin coupled to a railcar door of a railcar. The method further includes providing a compatible first tapered receiver coupled to the railcar. The method further includes moving the railcar door into a first position such that the tapered locking pin is aligned with the tapered receiver. The method further includes inserting the tapered locking pin into a portion of the tapered receiver. Inserting the tapered locking pin into the first tapered receiver secures the railcar door in a first position.

In certain embodiments, the method further includes providing a compatible second tapered receiver coupled to the railcar. The method further includes removing the first tapered locking pin from the first tapered receiver. The method further includes moving the railcar door into a second position such that the first tapered locking pin is aligned with the second tapered receiver. The method further includes inserting the first tapered locking pin into a portion of the second matching tapered receiver. Inserting the first tapered locking pin into the second tapered receiver secures the railcar door in the second position.

In certain embodiments, the method further includes providing a second tapered locking pin. The first tapered locking pin is disposed at a bottom of the railcar door and the second tapered locking pin is disposed at a top of the railcar door. In some embodiments, vertical movement of the second tapered locking pin is coupled to movement of the first tapered locking pin.

In certain embodiments, inserting the first tapered locking pin into a portion of the tapered receiver includes automatically inserting the first tapered locking pin into the portion of the tapered receiver using a spring.

In certain embodiments, removing the first tapered locking pin from the first tapered receiver includes rotating a square key hole coupled to the first tapered locking pin.

In certain embodiments, moving the railcar door into the second position includes rolling one or more wheels coupled to the railcar door along a track on the railcar.

According to certain embodiments, a railcar includes a railcar door, a first pair of receivers coupled to the railcar, and a second pair of receivers coupled to the railcar. The railcar door includes a top side, a bottom side opposite the top side, a first locking pin coupled to the railcar door at the bottom side, and a second locking pin coupled to the railcar door at the top side. Each of the first locking pin and the second locking pin includes an inserted portion at a first end of the respective locking pin. The inserted portion includes a pin taper in the direction towards the first end of the respective locking pin. The first pair of receivers each defines a recess. Each recess includes a receiver taper compatible with the pin taper. The second pair of receivers each defines a recess. Each recess includes a receiver taper compatible with the pin taper. The first pair of receivers are disposed at a portion of the railcar proximate the bottom side of the railcar door and the second pair of receivers are disposed at a portion of the railcar proximate the top side of the railcar door.

In certain embodiments, the railcar further includes a locking mechanism coupled to the first locking pin and second locking pin. Operating the locking mechanism causes the first locking pin and the second locking pin to be removed from one of the first pair of receivers and one of the second pair of receivers, respectively.

In certain embodiments, the railcar further includes a track disposed proximate to the bottom side of the railcar door. The railcar further includes one or more wheels coupled to the railcar door. The one or more wheels configured to roll along the track.

In certain embodiments, each of the first pair of receivers and the second pair of receivers correspond to two positions of the railcar door defined by alignment of the first locking pin with a first one of the first pair of receivers and the second locking pin with a first one of the second pair of receivers and alignment of the first locking pin with a second one of the first pair of receivers and the second locking pin with a second one of the second pair of receivers, respectively.

In certain embodiments, the railcar further includes a second railcar door, a third pair of receivers, and a fourth set of receivers. The second railcar door includes a top side, bottom side opposite the top side, a first locking pin coupled to the second railcar door at the bottom side, and a second locking pin coupled to the second railcar door at the top side. Each of the first locking pin and the second locking pin includes an inserted portion at a first end of the respective locking pin. The inserted portion includes a pin taper in the direction towards the first end of the respective locking pin. The third pair of receivers each defines a recess. Each recess includes a receiver taper compatible with the pin taper. The fourth pair of receivers each defines a recess. Each recess includes a receiver taper compatible with the pin taper. The third pair of receivers are disposed at a portion of the railcar proximate the bottom side of the second railcar door and the fourth pair of receivers are disposed at a portion of the railcar proximate the top side of the second railcar door.

Certain embodiments of the present disclosure may provide one or more technical advantages. For example, certain embodiments provide railcars with locking pins and receivers comprising compatible tapers. Providing compatible tapers allows the locking pins to be securely inserted within the receivers without gaps, thereby reducing the movement of railcar doors once secured. As another example, certain embodiments provide railcars with two locking pins both at the top of the railcar door and the bottom of the railcar door, each having a tapered inserted portion. In certain circumstances, the railcar door may be subject to a force at a top of the railcar door that may still cause movement in the railcar door if only secured by a single locking pin proximate the bottom of the railcar door. By securing the railcar door with tapered locking pins and compatibly tapered receivers at both the top and bottom of the railcar door, the railcar door may be further secured from moving during transportation or loading and unloading cargo. As yet another example, certain embodiments provide locking pins at the top and bottom of the railcar door that are coupled to the rotation of a square key hole defined in the railcar door. By coupling the locking pins to the square key hole, an operator may engage the square key hole to remove the locking pins from their respective receivers to allow the railcar door to move from an open to closed (or closed to open) position.

Other advantages may be readily apparent to one having skill in the art. Certain embodiments may have none, some, or all of the recited advantages.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a perspective view of an example railcar, according to certain embodiments;

FIG. 2A is an end view of the example railcar in FIG. 1 including one or more railcar doors in a first position, according to certain embodiments;

FIG. 2B is an end view of the example railcar in FIG. 1 including one or more railcar doors in a second position, according to certain embodiments;

FIG. 3 illustrates an example locking pin and receiver used to maintain a railcar door in an open position, according to certain embodiments;

FIGS. 4A and 4B illustrate an example tapered locking pin and tapered receiver used to secure a railcar door in an open or closed position in a secure and configuration, according to certain embodiments; and

FIG. 5 is a flowchart illustrating a method of securing a railcar door in a certain position relative to the railcar, according to certain embodiments.

### DETAILED DESCRIPTION

Railcars are used to transport goods, persons, and cargo to their destination. Auto Rack cars are a type of railcar used to store and transport vehicles (e.g., cars, trucks, motorcycles, etc.). Railcars, such as Auto Rack cars, have one or more access points through which cargo or goods may be loaded or unloaded. For example, Auto Rack cars may include one or more doors. These doors may be held open when accessing the interior of the railcar. Similarly, the doors may be held closed during transportation of the cargo on the railcar. Securing the doors in an open or closed position may help to prevent accidental injuries to operators, e.g., while accessing the interior of the railcar, or damage to cargo during the unloading/loading process or transportation.

Conventional railcars may use locking pins and receivers to secure the doors in an open or closed position. For example, a locking pin may be coupled to each door and the locking pin may be disposed in a recess of a receiver located on the railcar. For example, the locking pin and receiver may be positioned on the railcar door and railcar, respectively, such that the locking pin is disposed over the receiver when the door is open. While inserting the locking pin into the receiver may prevent the door from opening, existing locking pin and receiver pairs still allow for limited movement of the doors. Conventional receivers have a cylindrical recess in which a cylindrical portion of the locking pin, having a slightly smaller radius than that of the recess, is inserted. The difference in radius allows the locking pin to be inserted into the recess despite slight misalignments and ordinary mechanical wear on proximate components of the railcar door and railcar. This feature in conventional systems has several drawbacks. For example, the gaps between the locking pins and receivers allow the railcar doors to vibrate and move even when the locking pins are inserted into receivers. Thus, when the railcar is moving or when cargo is being loaded or unloaded, the railcar doors may move and vibrate. As a result, components of the railcar door and the railcar may show increased wear and tear. For example, a wheel allowing the railcar door to move between open and closed positions may cause wear on the wheel track as the railcar door vibrates. This wear may create undesirable grooves in the track that may interfere with the opening or closing of the railcar doors and may result in further uneven wear. Likewise, other mating components between the railcar and the railcar doors may be subject to increased wear due to the small vibrations and movements permitted by existing locking pins and receivers. The resulting wear may expedite the maintenance and/or replacement of components of the railcar, which may also increase the time the railcar is not in service.

Accordingly, certain embodiments of new systems and methods for railcar door locking pins and receivers are disclosed herein that address the problems identified above. Certain embodiments of the present disclosure may provide one or more technical advantages. For example, certain embodiments provide railcars with locking pins and receivers that reduce or eliminate gaps between the locking pins and receivers, thereby reducing or eliminating the movement of the railcar doors. In particular embodiments, the locking pin comprises an inserted portion that is tapered. The receiver defines a recess therein that may include a compatible taper. These tapers allow for the inserted portion of the locking pin to be securely inserted into the recess without gaps. Furthermore, even if portions of the receiver erode, e.g., due to insertion and removal of the locking pins, the locking pin may still be securely inserted without gaps between it and the receiver. Additional aspects of the present disclosure may be described further using examples and certain embodiments below.

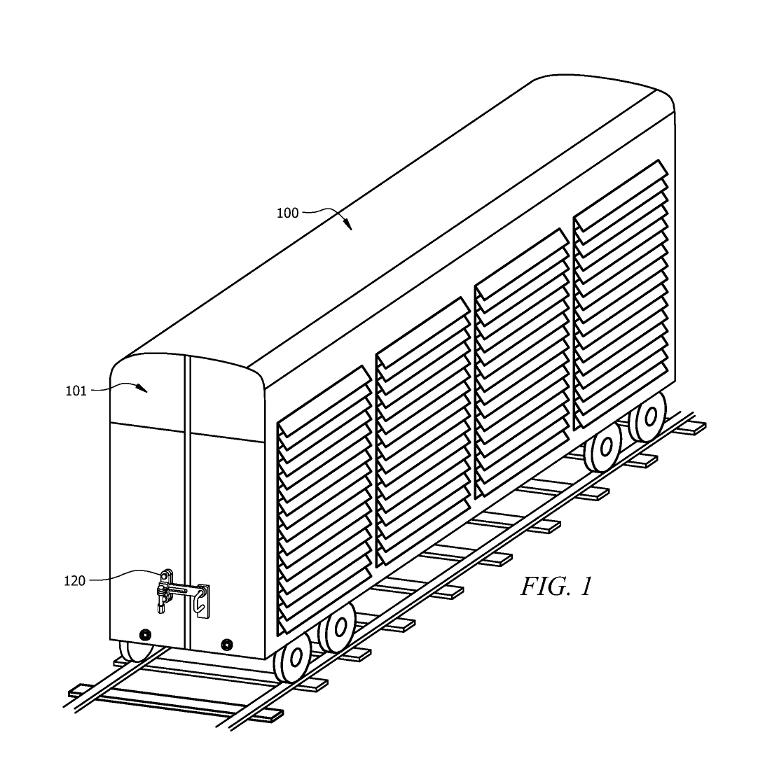

FIG. 1 is a perspective view of an example railcar 100, according to certain embodiments. Cargo may be loaded into railcar 100 and transported by railway to its destination. Railcar 100 may include one or more doors 101 that may be opened to allow access into the interior of railcar 100. In certain embodiments, doors 101 may be secured using security device 120 such that doors 101 may not be opened without first removing or disabling security device 120. For example, one or more doors 101 may be secured to each other or to a portion of railcar 100 using a hasp and security bolt, which must be removed before doors 101 may be opened.

One or more doors 101 may be opened to expose the interior of railcar 100 for loading, unloading, inspection, or other operations within railcar 100. In certain embodiments, one or more doors 101 are configured to open by disposing at least a portion of one or more doors 101 inside railcar 100. For example, railcar 100 may include an interior space in which one or more doors 101 may be moved, thereby reducing the obstruction caused by one or more doors 101 when opened. Once opened, it is desirable to maintain one or more doors 101 in a fixed position. For example, an operator may use a portion of one or more doors 101 to access the interior of railcar 100. As another example, cargo or an operator may inadvertently jostle one or more doors 101. By securing one or more doors 101 in the open position, one or more doors 101 may not be accidentally or otherwise closed or moved, which enhances the safety around railcar 100. Furthermore, reducing movement of one or more doors 101 may further reduce wear on components of railcar 100. In this manner, securing one or more doors 101 in a fixed or secured position may minimize damage to the cargo, injury to an operator, and excessive wear on movable components of one or more doors 101 and railcar 100.

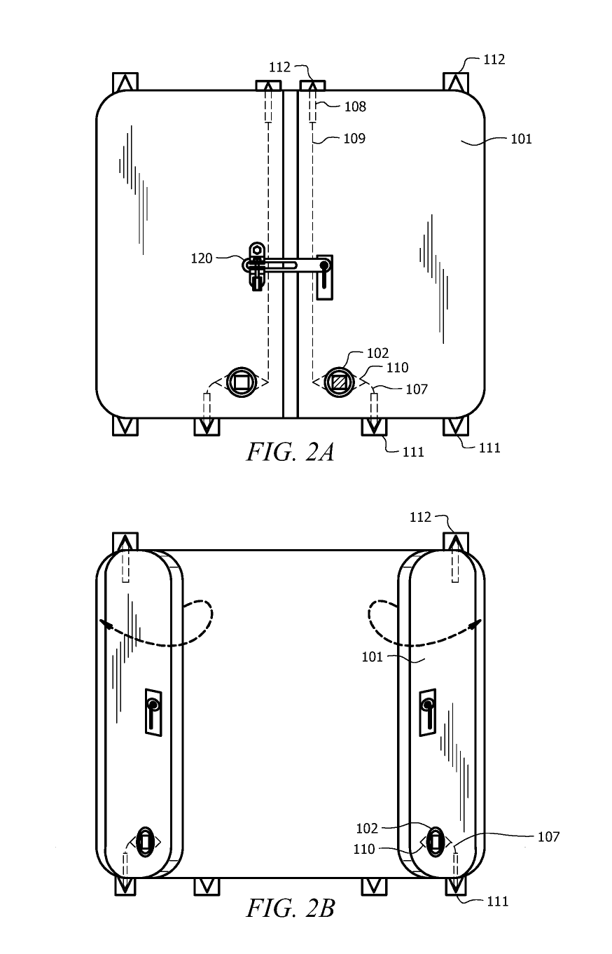

FIG. 2A is an end view of an embodiment one or more doors 101 of railcar 100 in a first position. Each of one or more doors 101 may include components that secure one or more doors in a closed position. In certain embodiments, each of one or more doors 101 may include a bottom locking pin 106, a top locking pin 108, first receivers 111, and second receivers 112. Bottom locking pin 106 and top locking pin 108 may be coupled to a respective one of one or more doors 101. First receivers 111 and second receivers 112 may be disposed proximate the bottom and top of the respective one of one or more doors 101, respectively. In this manner, bottom locking pin 106 may be oriented over one of first receivers 111 and top locking pin 108 may be oriented below one of second receivers 112 when the respective door 101 is in certain positions. When aligned, a portion of bottom locking pin 106 may inserted to one of first receivers 111 and a portion of top locking pin 108 may be inserted into one of second receivers 112, as illustrated. FIG. 2A illustrates one or more doors 101 in a closed position. At least one of first receivers 111 and one of second receivers 112 may be positioned on railcar 100 such that bottom locking pin 106 and top locking pin 108 are aligned, respectively, when one or more doors 101 are in a closed position. In this manner, bottom locking pin 106 and top locking pin 108 may be inserted, thereby securing one or more doors 101 in a closed position.

In certain embodiments, one or more doors 101 of railcar 100 may include a locking mechanism that engages bottom locking pin 106 and/or top locking pin 108. For example, in the illustrated embodiment, each of one or more doors 101 may include a square key hole 102 coupled to a turning member 110. Turning member 110 may be operable to turn when square key hole 102 is engaged. For example, an operator may insert a square key into square key hole 102 and rotate the square key inside square key hole 102, thereby engaging it and causing turning member 110 to rotate. Bottom locking pins 106 and top locking pins 108 may each be connected to turning member 110 by one or more connectors 107. Connectors 107 may couple the rotational movement of turning member 110 to the displacement of bottom locking pins 106 and top locking pins 108. For example, engaging the square key hole 102 may cause turning member 110 to rotate, thereby displacing connectors 107. Displacing connectors 107 may cause bottom locking pins 106 and top locking pins 108 to be removed from respective ones of first receivers 111 and second receivers 112. Once bottom locking pins 106 and top locking pins 108 are removed from first and second receivers 111 and 112, one or more end doors may be moved into a different position, e.g., from a closed position to an open position.

By disposing bottom locking pins 106 and top locking pins 108 into their respective receivers, doors 101 may be secured into a certain position. While secured in a certain position, doors 101 may still move or vibrate as a result of gaps or spaces between bottom locking pins 106 and top locking pins 108 and their respective receivers. This may cause unnecessary wear of components of doors 101 and/or railcar 100. For example, one or more doors 101 may include additional components that may exhibit wear due to these vibrations and permitted motion. For example, in certain embodiments, one or more doors 101 may include one or more wheels, such as steel or plastic tires, that follow a track coupled to railcar 100. Permitted vibrations and movement of one or more doors 101 may cause undue wear on these components. Accordingly, certain embodiments of locking pins and receivers described herein reduce or eliminate these types of movements and vibrations of one or more doors 101.

FIG. 2B is an end view of the example railcar 100 and one or more doors 101 in a second position, according to certain embodiments. When bottom locking pins 106 and top locking pins 108 are removed from first and second receivers 111 and 112, one or more doors 101 may move between a closed position and an open position (or vice versa). For example, one or more doors 101 may be moved from the position illustrated in FIG. 2A to the position in FIG. 2B. By moving one or more doors 101 to the second position the interior of railcar 100 may be exposed. Further, in the second position, bottom locking pins 106 and top locking pins 108 may be aligned with different respective receivers of first and second receivers 111 and 112. For example, one or both of first receivers 111 and second receivers 112 may include a receiver positioned on railcar 100 corresponding to one or more doors 101 positioned in an open position.

Once bottom locking pins 106 and top locking pins 108 are aligned with these respective receivers of first and second receivers 111 and 112, bottom locking pins 106 and top locking pins 108 may be inserted into the respective receivers. As described above with reference to FIG. 2A, inserting bottom locking pins 106 and top locking pins 108 into their respective receivers may secure one or more doors 101 in a fixed position, such as an open position in this example.

In certain embodiments, square key hole 102 is accessible while one or more doors 101 are in an open position. Square key hole 102 may again be engaged to remove bottom locking pins 106 and top locking pins 108 from their respective receivers when one or more doors 101 are ready to be moved into another position.

While one or more doors 101 are depicted as included two doors, railcar 100 may include only a single movable door. Similarly, in certain embodiments may only include one locking pin per door. In some embodiments, top locking pin 108 and bottom locking pin 106 are engaged by different mechanisms. In some embodiments top locking pin 108 and bottom locking 106 for each of the two doors 101 are engaged through a single mechanism. Additionally, in the depicted example, square key hole 102 is coupled to both bottom locking pin 106 and top locking pin 108. In certain embodiments, there may only bottom locking pin 106. In other embodiments, there may be more additional locking pins than bottom locking pins 106 and top locking pins 108. In certain embodiments, a single square key hole 102 may be engaged to unlock more than one door 101 of a railcar 100. For example, a single square key hole 102 may be coupled to bottom locking pins 106 and top locking pins 108 of two doors 101.

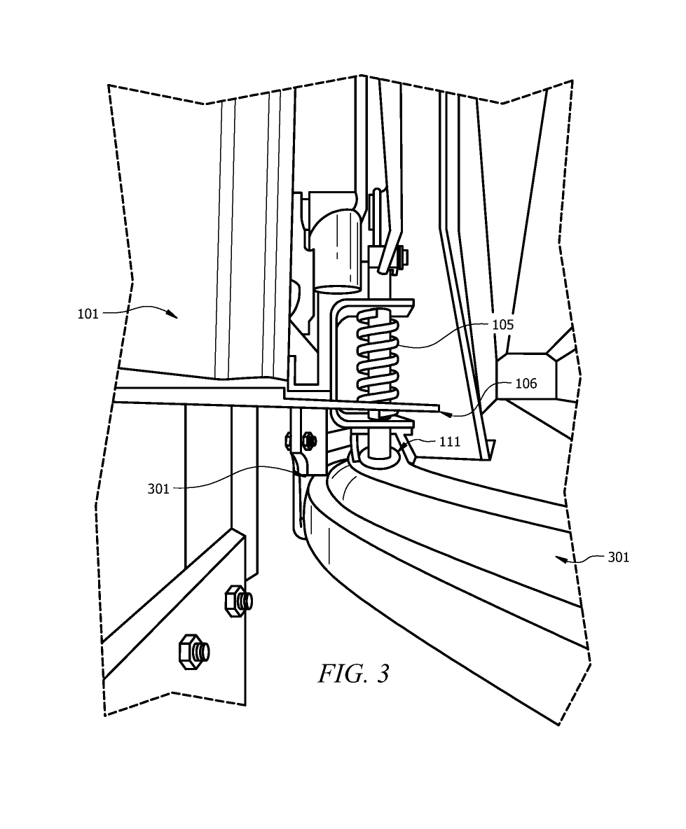

FIG. 3 illustrates an example door 101 and door movement mechanism of railcar 100. In certain embodiments, railcar 100 includes a track 301 on which a wheel 302 coupled to door 101 may traverse. Wheel 302 may aid in moving door 101 from an opened position to a closed position and vice versa. When opening or closing door 101, bottom locking pin 106 may be engaged such that locking pin 106 is lifted away from railcar 100. When door 101 reaches a closed or opened position, bottom locking pin 106 may be inserted within one or first receivers 111.

In certain embodiments, one or both of bottom locking pins 106 and top locking pins 108 may each be coupled to a spring or other restorative force mechanism. For example, bottom locking pin 106 may be coupled to spring 105. Spring 105 may provide a force on bottom locking pin 106 towards first receivers 111. For example, spring 105 may push a portion of bottom locking pin 106 into one of first receivers 111 when bottom locking pin 106 and the respective one of first receivers 111 are aligned. Similarly, springs coupled to top locking pins 108 may be used to insert top locking pins 108 into respective second receivers 112. The force of spring 105 may be counteracted by engaging square hole key 102 coupled to one or more of bottom locking pins 106 and top locking pins 108.

In some embodiments, railcar 100 comprises two first receivers 111 for each bottom locking pin 106 and two second receivers 112 for each top locking pin 108. For example, when bottom locking pin 106 is inserted into a first receiver of first receivers 111 and top locking pin 108 is inserted into a first receiver of second receivers 112, door 101 is secured in an opened position and when bottom locking pin 106 is inserted into a second receiver of the first receivers 111 and top locking pin 108 is inserted into a second receiver of the second receivers 112, door 101 may be secured in a closed position.

Wheel 302 may allow one or more doors 101 to move between open and closed positions based on the wheels movement along track 301. Wheel 302 and track 301 may wear normally through the process of opening and closing, e.g., through transverse movement of one or more doors 101. Additionally, they may exhibit wear due to the vibrations and limited movement resulting from gaps or spaces between bottom locking pins 106 and top locking pins 108 and their respective receivers. For example, existing locking pin and receiver pairs provide some space between the respective components that causes movements of doors 101 during the operation of railcar 100. Lateral and vertical movement of door 101 may cause wheel 302 and other components of door 101 to move relative to portions of railcar 100. For example, wheel 302 may move with door 101, while track 301 may move with the rest of railcar 100. As a result, wear may cause small indents in track 301 and flat spots on wheels 302, increasing the effort to open and close doors 101. The excessive wear may necessitate additional maintenance, repair, or replacement. For example, tracks may be repaired by hard facing the tracks and grinding the tracks to smooth them and wheels may be replaced earlier than intended. In addition, bearings of bottom locking pin 106 or the lube cups in the mounting bracket of receivers 111 may require earlier replacement Furthermore, worn components of door 101 or railcar 100 may prevent or impede use of railcar 100.

In certain embodiments, bottom locking pins 106 and top locking pins 108 each comprise a taper along a portion of the respective locking pin. For example, the portion to be inserted into a respective receiver may be tapered. Similarly, the recess defined by the respective receiver may also include a compatible taper. By providing each receiver-locking pin pair or triplet with compatible tapers, the space between those components may be reduced or eliminated. In this manner, the above described wear may be avoided.

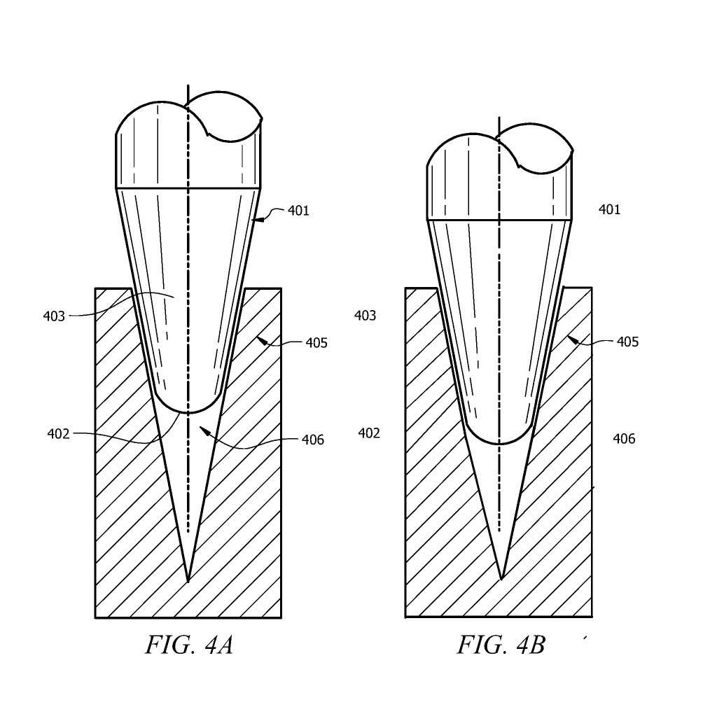

FIG. 4A illustrates an example tapered locking pin 401 and tapered receiver 405 used to secure a door 101 of railcar 100 in an open or closed position, according to certain embodiments. For example, one or both of bottom locking pins 106 and top locking pins 108 may be tapered locking pins, such as tapered locking pin 401. Likewise, one or both of first receivers 111 and second receivers 112 may be tapered receivers, such as tapered receiver 405. In certain embodiments, one or more doors 101 of railcar 100 may be secured in an opened or closed position using tapered locking pin 401 and tapered receiver 405 with a compatible tapered recess 406. In some embodiments, tapered locking pin 401 and receiver 405 may have the same or matching tapers. In this manner, the compatible tapers of the respective components may ensure a comprehensive contact of tapered locking pin 401 inside of recess 406 of tapered receiver 405.

In certain embodiments, tapered locking pin 401 includes a first end 402 oriented in the direction of tapered receiver 405 when tapered locking pin 401 and tapered receiver 405 are aligned. Tapered locking pin 401 may further include an inserted portion 403 proximate first end 402. Inserted portion 403 may be configured to be inserted, partially or wholly, within tapered recess 406 of tapered receiver 405. In some embodiments, when inserted portion 403 is inserted within tapered recess 406 of tapered receiver 405, locking pin 401 restricts movement of door 101. For example, inserted portion 403 may be inserted securely within tapered recess 406 such that there is little or no space between tapered receiver 405 and inserted portion. Accordingly, tapered pin 401, and door 101 to which it is coupled, may be restricted. Door 101 being restricted may mean that door 101 cannot move at all, that only a portion of door 101 can move, that door 101 can only move in certain directions, that door 101's movements are limited within a limited distance, etc.

In certain embodiments, first end 402 of tapered locking pin 401 may have a rounded shape. The rounded shape may aid in the insertion of tapered locking pin 401. For example, as door 101 is moved to align tapered locking pin 401 and tapered recess 405, tapered locking 401 may begin to slide into tapered recess 405, which may aid in moving door 101 into the correct alignment and inserted portion 403 is inserted into tapered receiver 405. Having a rounded first end 402 may ease the transition of tapered locking pin 401 into tapered receiver 405. In other certain embodiments first end 402 of tapered locking pin 401 may comprise a flat surface. First end 402 may comprise any suitable shape allowing inserted portion 403 to be inserted within tapered recess 406 of receiver 405.

As illustrated, tapered locking pin 401 may be aligned above tapered receiver 405, such that moving tapered locking pin 401 downwards causes inserted portion 403 to be inserted within tapered recess 406 of receiver 405. For example, tapered locking pin 401 and tapered receiver 405 may have similar relative orientations as bottom locking pin 106 and first receivers 111. In certain embodiments, tapered receiver 405 is oriented above tapered locking pin 401, such that moving tapered locking pin 401 upwards causes the inserted portion 403 to be inserted within tapered recess 406 of receiver 405. For example, tapered locking pin 401 and tapered receiver may have similar relative orientations as top locking pin 108 and second receivers 112. In certain embodiments, tapered locking pin 401 is oriented to the side of receiver 405 such that moving tapered locking pin 401 in right (left) causes inserted portion 403 to be inserted within tapered recess 406 of receiver 405. Door 101 of railcar 100 may include one or more tapered locking pins 401 and tapered receivers 405 in any orientation or combination of orientations described above. While certain directions and orientations have been discussed in this disclosure, any suitable orientation is additionally contemplated.

In certain embodiments, tapered receiver 405 may include a bushing. The bushing may wholly or in part define tapered recess 406 of tapered receiver 405. The bushing of tapered receiver 405 may be replaceable independently of replacing the remainder of tapered receiver 405. For example, after a period of time, the bushing may be replaced without having to replace tapered locking pin 401 or the remainder of receiver 405. In this manner, tapered locking pin 401 and receiver 405 combination may be more easily maintained and reduce maintenance and parts costs.

In certain embodiments, tapered receiver 405 may be lubricated. Lubrication may be used to reduce wear on tapered receiver 405 and tapered locking pin 401. In some embodiments, tapered receiver 405 comprises a material that is self-lubricating. For example, tapered receiver 405 may include a bushing made out of an oil-impregnated material. Oil may be released from the bushing as its surface is worn down. In some embodiments, tapered receiver 405 may be lubricated as a separate process of maintaining railcar 100.

While tapered receiver 405 has been discussed as a separable component of railcar 100, receiver 405 may also be an integrated part of railcar 100 and components thereof. For example, receiver 405 may be integrated into track 301 coupled to railcar 100. In certain embodiments, track 301 may be manufactured with two receivers, each of the two receivers 405 associated with an opened or closed position of door 101. For example, door 101 may be movable along track 301 between an opened position and closed position, wherein the two receivers 405 may accept tapered locking pin 401 coupled to door 101 and operate to maintain door 101 secure in each position, respectively.

In certain embodiments, tapered receiver 405 may also include a rubber mounting. The rubber mounting may mount a portion of receiver 405 to a portion of railcar 100. In some embodiments, the rubber mounting is separable from receiver 405 to allow for its replacement independent from the rest of receiver 405. The rubber mounting may comprise any suitable rubber or material.

In certain embodiments, a portion of tapered locking pin 401 includes a taper such that the radius of the cross section of the tapered portion of tapered locking pin 401 decreases towards first end 402. In certain embodiments, tapered recess 406 of receiver 405 includes a compatible taper. For example, tapered recess 406 of tapered receiver 405 may include a taper compatible with the taper of tapered locking pin 401 such that inserted portion 403 of tapered locking pin 401 may fit within tapered recess 406 with the sides of inserted portion 403 flush against the interior of tapered receiver 405. In other words, tapered recess 406 may define a recess having a cross section with a radius that decreases in a compatible manner to the taper of tapered locking pin 401.

In some embodiments, tapered recess 406 and tapered locking pin 401 have the same taper. As an example, tapered recess 406 and tapered locking pin 401 both have a ½ inch per linear foot taper. In this manner, the matching tapers may securely maintain the inserted portion 403 of tapered locking pin 401 inside tapered recess 406 of tapered receiver 405. In other embodiments, tapered recess 406 and tapered locking pin 401 may have different tapers that are compatible. In some embodiments, the tapers for each of tapered locking pin 401 and tapered recess 406 of tapered receiver 405 are based on their respective material composition. For example, the amount of taper may be based on an optimal range of taper for securing two materials together. In this manner, the respective tapers provide a more secure fit between tapered locking pin 401 and tapered recess 405, which may reduce or eliminated movement and vibration of doors 101 of railcars 100 in opened or closed positions.

FIG. 4B illustrates example tapered locking pin 401 and tapered receiver 405 in a worn-in condition. An additional advantage of certain embodiments is that despite normal wear of the locking pin-receiver combination, spaces and gaps are still eliminated between tapered locking pin 401 and receiver 405. For example, portions of tapered recess 406 of receiver 405 may erode due to the insertion and removal of inserted portion 403 of tapered locking pin 401. Even after wearing down, tapered locking pin 401 is still secure inside receiver 405 when inserted. For example, the force inserting tapered locking pin 401 into receiver 405 may push a larger portion of tapered locking pin 401 inside tapered recess 406 of tapered receiver 405. In some embodiments, tapered locking pin 401 is inserted into tapered receiver 405 via a spring force, which will only be balanced once tapered locking pin 401 is secure within tapered receiver 405. In contrast, wear on conventional locking pin and receiver pairs may result in further movement of the doors of the railcars during operation, which, in turn, may further wear the locking pin and receiver pair and other railcar parts. In this manner, receiver 405 and/or tapered locking pin 401 may continue to operate as intended despite normal wear.

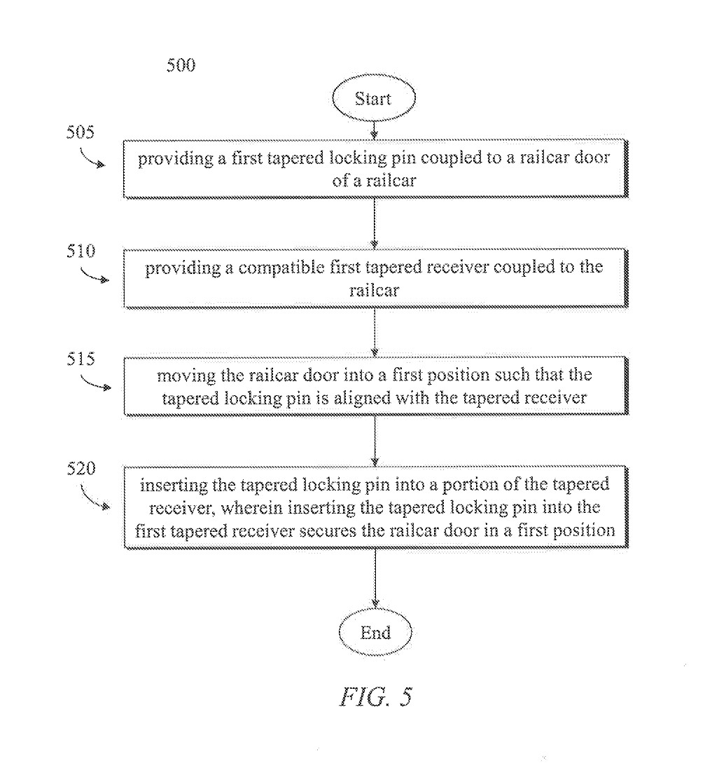

FIG. 5 is a flowchart illustrating a method 500 of securing a railcar door. Method 500 may begin with step 505. At step 505, a first tapered locking pin is provided. For example, tapered locking pin 401 may be provided. The tapered locking pin may be coupled to a railcar door of a railcar. As an example, the first tapered locking pin may be coupled to the bottom or top of the railcar doors as bottom locking pin 106 or top locking pin 108.

At step 510, a matching tapered receiver, such as tapered receiver 405, is provided. The matching tapered receiver may be coupled to a railcar, such as an autorack car. For example, the matching tapered receiver may be coupled to the railcar as one of first receivers 111 or one of second receivers 112.

At step 515, the railcar door is moved into an open position such that the provided tapered locking pin is aligned with the matching tapered receiver. For example, the railcar door may be moved from the position illustrated in FIG. 2A to the position of FIG. 2B. In some embodiments, the railcar door is automatically aligned such that the tapered locking pin and matching tapered receiver are aligned. For example, the railcar door may be configured to move between two extreme positions. At each end point, the tapered locking pin and a tapered receiver may be aligned.

At step 520, the tapered locking pin is inserted into a portion of the matching tapered receiver. The insertion of the tapered locking pin inside the matching tapered receiver may secure the railcar door in the open position. In some embodiments, the tapered locking pin is inserted into the tapered receiver using a spring force.

In certain embodiments, method 500 may further comprise additional steps. For example, method 500 may comprise the step of providing a second matching tapered receiver corresponding to a closed position. Method 500 may further comprise the steps of removing the tapered locking pin from the first tapered receiver, moving the railcar door to a closed position, and inserting the tapered locking pin into the second matching tapered receiver. For example, moving the railcar door into a closed position may include removing the tapered locking pin from the matching receiver associated with the open position before engaging the railcar door to move it. In this manner, the railcar door may be secured in a closed position. For example, railcar may be transported while its railcar doors are in the closed position. Securing the doors with the tapered locking pin and matching tapered receiver, reduces or eliminates movement of the doors and reduces the wear on the doors and other components of the railcar.

In certain embodiments, method 500 may be performed by a railcar installer, an operator, or a railcar manufacturer. For example, an operator may perform method 500 when accessing the interior of railcar 100 or when securing doors 101 of railcar 100 shut for transportation. In certain embodiments, method 500 may be performed with a new railcar, or alternatively, as part of a retrofitted railcar. For example, a railcar may be retrofitted with one or more tapered locking pins 401 and tapered receivers 405 to eliminate or reduce wear on the railcar.

Any steps or features described herein are merely illustrative of certain embodiments. It is not required that all embodiments incorporate all the steps or features disclosed nor that the steps be performed in the exact order depicted or described herein. Furthermore, some embodiments may include steps or features not illustrated or described herein, including steps inherent to one or more of the steps disclosed herein.

Modifications, additions, or omissions may be made to the methods described herein without departing from the scope of the disclosure. The methods may include more, fewer, or other steps. Additionally, steps may be performed in any suitable order.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

1. An apparatus, comprising:
one or more locking pins coupled to a railcar door of a railcar, each locking pin comprising an inserted portion at a first end of the locking pin, wherein the inserted portion comprises a pin taper in the direction towards the first end of the locking pin; and
a first receiver coupled to the railcar, the first receiver defining a recess, wherein the recess comprises a receiver taper compatible with the pin taper;
wherein the inserted portion of a respective one of the one or more locking pins inserted into the recess of the first receiver restricts movement of the railcar door.

2. The apparatus of claim 1, wherein the one or more locking pins comprise a first locking pin and a second locking pin, wherein the first locking pin is disposed proximate a bottom of the railcar door and the second locking pin is disposed proximate a top of the railcar door.

3. The apparatus of claim 1, further comprising a second receiver coupled to the railcar, the second receiver defining a recess, wherein the recess comprises a receiver taper compatible with the pin taper.

4. The apparatus of claim 3, wherein:
a position of the first receiver corresponds to a closed position of the railcar door; and
a position of the second receiver corresponds to an open position of the railcar door.

5. The apparatus of claim 1, wherein each of the one or more locking pins is coupled to a spring, wherein the spring is configured provide a force on the respective locking pin to insert the inserted portion of the respective locking pin into the first receiver when the respective locking pin is disposed over the first receiver.

6. The apparatus of claim 1, wherein the one or more locking pins are coupled to the rotation of a square key hole defined in the railcar door such that a respective locking pin is removed from the first receiver when the square key hole is rotated.

7. The apparatus of claim 1, wherein the first receiver is lubricated.

8. The apparatus of claim 1, wherein the pin taper and the receiver taper are the same taper.

9. A method, comprising:
providing a first tapered locking pin coupled to a railcar door of a railcar;
providing a compatible first tapered receiver coupled to the railcar;
moving the railcar door into a first position such that the tapered locking pin is aligned with the tapered receiver;
inserting the tapered locking pin into a portion of the tapered receiver, wherein inserting the tapered locking pin into the first tapered receiver secures the railcar door in a first position.

10. The method of claim 9, further comprising:
providing a compatible second tapered receiver coupled to the railcar,
removing the first tapered locking pin from the first tapered receiver;
moving the railcar door into a second position such that the first tapered locking pin is aligned with the second tapered receiver; and
inserting the first tapered locking pin into a portion of the second matching tapered receiver, wherein inserting the first tapered locking pin into the second tapered receiver secures the railcar door in the second position.

11. The method of claim 9, further comprising providing a second tapered locking pin, wherein the first tapered locking pin is disposed at a bottom of the railcar door and the second tapered locking pin is disposed at a top of the railcar door.

12. The method of claim 11, wherein vertical movement of the second tapered locking pin is coupled to movement of the first tapered locking pin.

13. The method of claim 9, wherein inserting the first tapered locking pin into a portion of the tapered receiver comprises automatically inserting the first tapered locking pin into the portion of the tapered receiver using a spring.

14. The method of claim 10, wherein removing the first tapered locking pin from the first tapered receiver comprises rotating a square key hole coupled to the first tapered locking pin.

15. The method of claim 10, wherein moving the railcar door into the second position comprises rolling one or more wheels coupled to the railcar door along a track on the railcar.

16. A railcar, comprising:
a railcar door comprising:
a top side;
a bottom side opposite the top side:
a first locking pin coupled to the railcar door at the bottom side;
a second locking pin coupled to the railcar door at the top side;
wherein each of the first locking pin and the second locking pin comprises an inserted portion at a first end of the respective locking pin, the inserted portion comprising a pin taper in the direction towards the first end of the respective locking pin; and
a first pair of receivers coupled to the railcar, the first pair of receivers each defining a recess, wherein each recess comprises a receiver taper compatible with the pin taper; and
a second pair of receivers coupled to the railcar, the second pair of receivers each defining a recess, wherein each recess comprises a receiver taper compatible with the pin taper;
wherein the first pair of receivers are disposed at a portion of the railcar proximate the bottom side of the railcar door and the second pair of receivers are disposed at a portion of the railcar proximate the top side of the railcar door.

17. The railcar of claim 16, further comprising a locking mechanism coupled to the first locking pin and second locking pin, wherein operating the locking mechanism causes the first locking pin and the second locking pin to be removed from one of the first pair of receivers and one of the second pair of receivers, respectively.

18. The railcar of claim 16, further comprising:
a track disposed proximate to the bottom side of the railcar door; and
one or more wheels coupled to the railcar door, the one or more wheels configured to roll along the track.

19. The railcar of claim 16, wherein each of the first pair of receivers and the second pair of receivers correspond to two positions of the railcar door defined by alignment of the first locking pin with a first one of the first pair of receivers and the second locking pin with a first one of the second pair of receivers and alignment of the first locking pin with a second one of the first pair of receivers and the second locking pin with a second one of the second pair of receivers, respectively.

20. The railcar of claim 16, further comprising:
a second railcar door comprising:
a top side;
a bottom side opposite the top side:
a first locking pin coupled to the second railcar door at the bottom side;
a second locking pin coupled to the second railcar door at the top side;
wherein each of the first locking pin and the second locking pin comprises an inserted portion at a first end of the respective locking pin, the inserted portion comprising a pin taper in the direction towards the first end of the respective locking pin; and
a third pair of receivers coupled to the railcar, the third pair of receivers each defining a recess, wherein each recess comprises a receiver taper compatible with the pin taper; and
a fourth pair of receivers coupled to the railcar, the fourth pair of receivers each defining a recess, wherein each recess comprises a receiver taper compatible with the pin taper;
wherein the third pair of receivers are disposed at a portion of the railcar proximate the bottom side of the second railcar door and the fourth pair of receivers are disposed at a portion of the railcar proximate the top side of the second railcar door.
